(19) United States
(12) Patent Application Publication
(10) Pub. No.: US 2008/0173559 A1
(43) Pub. Date: Jul. 24, 2008

(54) Creating sleeves from standard paper

(76) Inventor: Ronen Senator, Long Beach, NY (US)

Correspondence Address: Ronen Senator, 111 Camdike St., Valley Stream, NY, 11580, US

(21) Appl. No.: 11/655,021

(22) Filed: Jan. 18, 2007

(51) Int. Cl. B65D 85/57; B31B 1/26

(52) U.S. Cl. 206/308.1; 493/162

(57) ABSTRACT

A system and method for creating sleeves for CDs, DVDs, and similarly dimensioned disks, in order to identify, protect, and store disks. An end-user would use a computer software application that uses a device to print out folding guidelines onto a standard sheet of paper. This printout may include a front and/or back image. The user would then fold the standard sheet, using the printed guidelines, into a useable sleeve.

The term ‘standard paper’ or ‘standard sheet’, as it is used in this patent application, refers to the 8.5 inch by 11 inch paper most commonly used.

The term ‘sleeve’ or ‘sleeves’, as it is used in this patent application, is meant to refer to a covering for CDs and DVDs and other similarly dimensioned disks. The term ‘sleeve’, may also be commonly referred to as ajacket, envelope, slip, or cover. This patent application will hereafter use the term ‘sleeve’ to encompass all the names applied to the stated concept.

### BACKGROUND OF THE INVENTION

There seems to be no apparent standard for labeling ‘home-made’ CDs and DVDs. Labeling with an adhesive directly onto the CD or DVD is not necessarily in favor due to arguments over whether the adhesive may shorten the life expectancy of the disks. The same argument exists with regards to felt tip markers, and in addition, it takes a skilled hand to write anything legible with markers.

Those are the labeling methods that end-users generally use currently, neither of which offer any protection to the disk itself. To offer sufficient protection to the disk an end-user must also use a jewel case or sleeve.

Currently, disks are often purchased in spindles, creating many loose CDs and DVDs, often left unlabeled, or more commonly, only partially labeled. This often creates a time consuming search for the disk that the user is looking for.

There exists a dire need for an easy way of labeling these disks. If the label can also accommodate and protect that disk, the utility would save time and money.

### BRIEF SUMMARY OF THE INVENTION

In it's primary embodiment, this invention is a system for folding standard 8.5 inch by 11 inch paper into CD and DVD sleeves. This embodiment employs a computer software program using a printer. The software program instructs the printing of folding guidelines, then the end-user folds along the guidelines to create the sleeve.

The appearance of the sleeve itself can range widely from highly decorative and ornamental through strictly expressing the contents of the disk that it is accommodating. It can also be blank, used primarily to protect a disk from scratches.

### BRIEF DESCRIPTION OF THE SEVERAL VIEWS OF THE DRAWING

FIG. 1 This invention in it's pre-folded state. Picture includes the folding guidelines along with an example for a front and back cover.

FIG. 2 This invention with optional borders.

FIG. 3A-3F Drawings depicting the steps for folding.

FIG. 4 Color photograph of this invention with borders. The photo depicts completed sleeves which are lined up. This demonstrates the added utility of distinctive borders.

### DETAILED DESCRIPTION OF THE INVENTION

Folding guidelines are drawn or printed on standard paper and then folded into a sleeve which can accommodate DVDs, CDs, and similarly dimensioned disks.

Once the sleeve is printed it needs to be folded. The completed sleeve requires 4 folds. This leaves a flap overhang which is tucked into a lip formed by prior folds. This completes the sleeve and readies it for housing the disk.

Holding the unfolded sleeve, printed on a standard sheet, in portrait view, there are two vertical folding guidelines and two horizontal folding guidelines. One of the horizontal lines should be 4.75 inches from the top or bottom edge of the paper sheet. The next horizontal line should be 4.8125 inches from the initial horizontal guideline. The vertical guidelines should be 4.8125 inches apart from each other, with wide tolerances toward either the right or left edge of the page, however, in its preferred embodiment, the vertical guidelines should be centered on the page. It is advisable that the vertical guidelines be tapered or biased sufficiently to allow the flap to easily tuck in during the folding process.

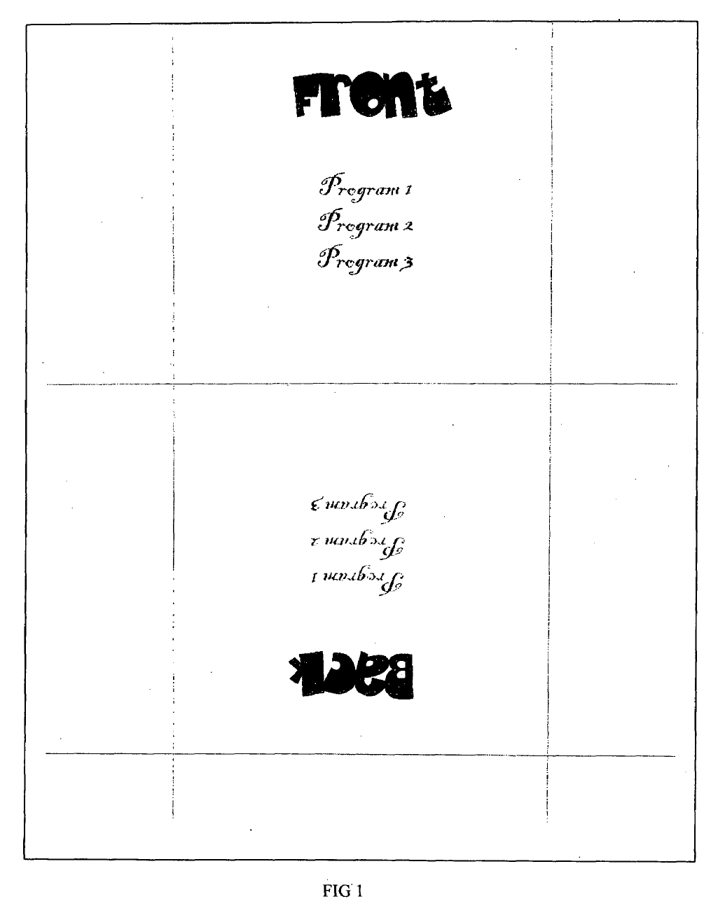

FIG. 1 shows an example of a pre-folded sleeve. The picture depicts the folding guidelines and their preferred position on a standard sheet, along with an example front and back image, which is what the preferred embodiment suggests should accompany the folding guidelines.

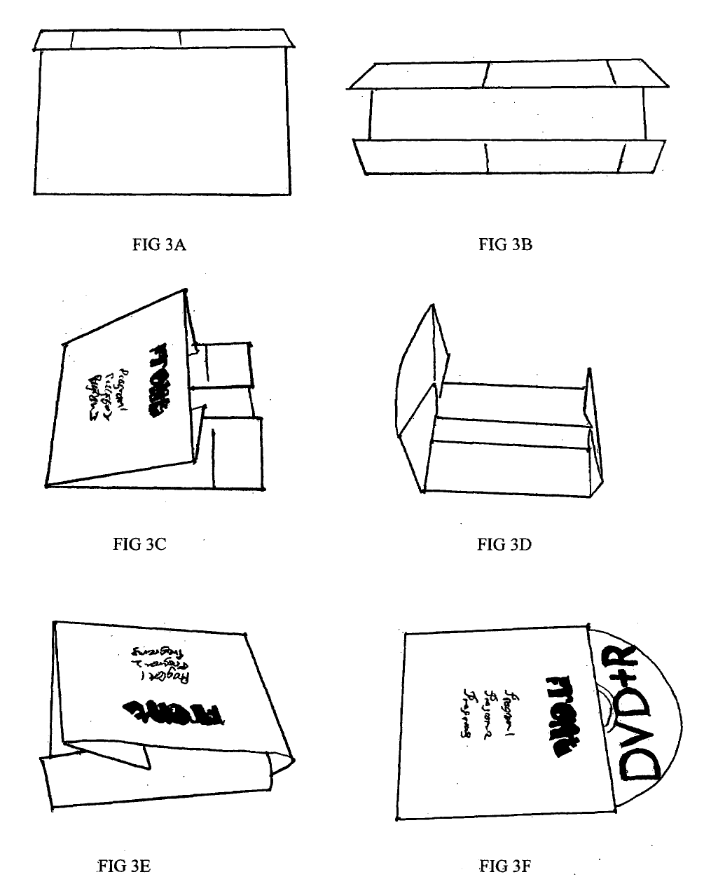

To create the sleeve from the printout, a user must fold the paper. Make the first fold along one of the vertical folding guidelines (FIG. 3A), the guidelines being on the outside of all the folds. The next fold should be along the other vertical guideline (FIG 3B). The third fold should be along the horizontal folding guideline that is closest to the center of the standard sheet (FIG. 3C). The fourth fold would be at the other horizontal folding guideline (FIG. 3D). The final step is to tuck the short flap, that is produced though the fold, into the lip of front flap (FIG. 3E). The disk slips into the resulting pocket (FIG. 3F).

Folding guidelines are usually meant to be thin and discrete as they would appear on the outside of the fold. The folding guidelines may alternately be dotted or dashed.

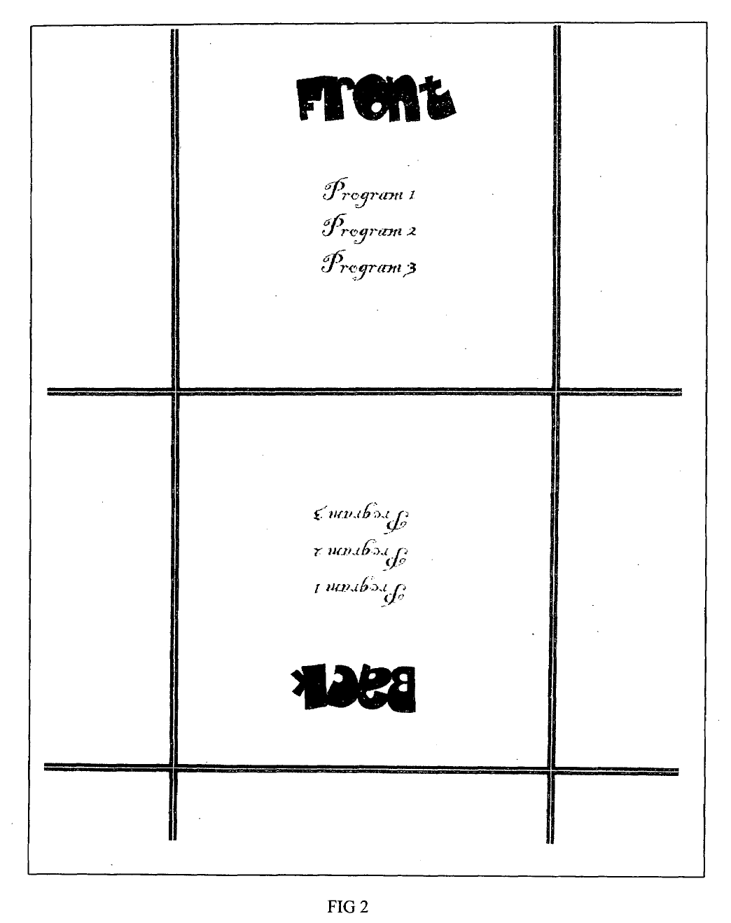

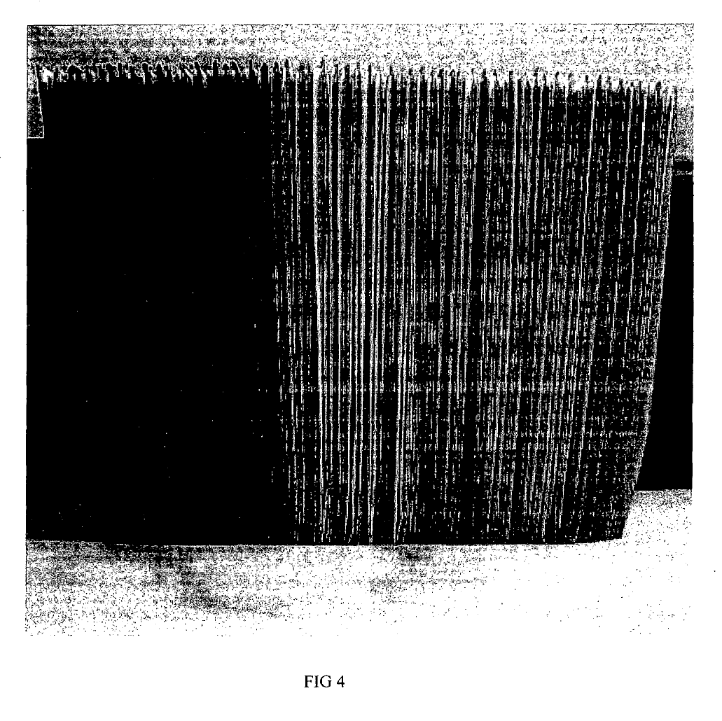

Folding guidelines can also be used as borders for the sleeve as pictured in FIG. 2. The borders can be of variable thickness, and in addition, have decorative features depending on the needs or preferences of the end-user. The borders, while possibly decorative, have the additional utility of a distinguishing mark when stacked or lined up as shown in FIG. 4.

The sleeve, while intended to be used to house, label, and store the disks, can also slip into a standard CD jewel case to serve as a cover.

Through a software application, sleeves can be saved or retrieved for duplication later or to catalog the disks. It is preferred to save the front and back image of the sleeve as the retrieval process will be facilitated by the end-user recognizing the image of the cover. Additionally, end-users would have an opportunity to save the image of the pre-folded sleeve on a memory card to be used on a printer directly.

Paper could be customized to include perforations that facilitate the folding process where guidelines would not be necessary. Software could be designed to print on the customized paper which would add the front and back design without guidelines.

The sleeves are meant to be conveniently stacked or lined up, as a great number of sleeves take up a small amount of space, but to store or transport a multitude of sleeves, a customized case is an option. A flip type case or rolodex type case is a suitable design.

Any practitioner of computer programming can achieve the printing of folding guidelines along with images with little effort.

1. A method for creating DVD sleeves, CD sleeves, and sleeves for similarly dimensioned disks, using standard paper whereby folding guidelines are printed onto standard paper and then folded to construct a sleeve.

2. A computer software application designed to achieve claim 1.

3. Computer software application that creates computer readable output files for the purposes of creating claim 1.

4. A computer software application that saves and catalogs sleeves as described in claim 1.

5. Customized paper that is perforated in such a way as to facilitate the folding of paper as described in claim 1.

6. Software that is designed to print on paper as described in claim 5.

7. A container designed to house a quantity of sleeves created as described in claim 1 and claim 5.
